(19) United States
(12) Patent Application Publication
(10) Pub. No.: US 2013/0336085 A1
(43) Pub. Date: Dec. 19, 2013

(54) Method and Apparatus for Mixing Drinks

(71) Applicants: Michael Drake, Woodland Hills, CA (US); Daniella Drake, Woodland Hills, CA (US)

(72) Inventors: Michael Drake, Woodland Hills, CA (US); Daniella Drake, Woodland Hills, CA (US)

(21) Appl. No.: 13/525,594

(22) Filed: Jun. 18, 2012

(51) Int. Cl. B65D 25/08; A23L 2/38; B01F 13/00

(52) U.S. Cl. 366/348; 206/219

(57) ABSTRACT

An improved mixing bottle comprised of at least two chambers, a top chamber and a bottom chamber. Said chambers may be separated from one another, on the outside, by a freshness seal and, on the inside, by a permeable membrane. The top chamber interior will contain a wide mouth funnel with a wide end and a narrow end. While the freshness seal is still in tact, the narrower end of the funnel may point towards the bottom chamber and be situated somewhere just above the permeable membrane.

### CROSS-REFERENCE TO RELATED APPLICATIONS

None

### BACKGROUND

The following is a tabulation of some prior art that presently appears relevant:

U.S. Patents

| Patent Number | Kind Code | Issue Date | Patentee |
|---|---|---|---|
| 5,387,034 | A | Feb. 7, 1995 | Bauer et al. |
| 6,209,757 | B1 | Apr. 3, 2001 | Dumont |
| 7,036,975 | B2 | May 2, 2006 | Renz |
| 7,150,369 | B1 | Dec. 19, 2006 | Fryar |

U.S. Patent Application Publications

| Publication Number | Kind Code | Publ. Date | Applicant |
|---|---|---|---|
| None found | | | |

Foreign Patent Document

None found

Nonpatent Literature Documents

None found

### Notice of Copyright and Trade Dress

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### Discussion of the Related Art

In the field of fluid containers it is often desirable to maintain a separation between two components contained therein and then to later mix them to create an entirely new solution. There are many reasons why it is beneficial to separate components before they are combined to make a solution. Separating the components may enhance the nutritional value, increase the shelf life, reduce the number of contaminants in the final solution, or make possible drinks which could not exist otherwise.

It is often desirable to keep two or more components which will later be combined to form a final solution separated until just prior to when they will be used. It is even more desirable if all these components could be stored within a single apparatus that maintains the integrity of each individual substance and then allows the user to quickly and easily combine them all.

In the case of energy drinks with nutritional supplements contained therein, it is advantageous to keep components of a drink separate prior to consumption. Components in the drink which enhance the nutritional value such as vitamins, amino acids, and proteins, may degrade over time. The degradation process is hastened by exposure to a solvent which may denature these nutrients. Therefore it is beneficial to isolate them until it is necessary to combine with the solvent to make it drinkable.

An improved mixing apparatus with quick mix functionality is a beneficial way of allowing two or more components to be separated within a single container just prior to use. Although several types of content mixing bottles have been proposed, all of the bottles heretofore known suffer from a number of disadvantages:
(a) none of the known mixing bottles comprise a freshness seal that prevents any accidental mixing of the components;
(b) none of the known mixing bottles comprise a penetrable membrane that can be easily ruptured via a storage chamber funnel;
(c) few, if any, of the known mixing bottles work equally well whether the separated components are solids or liquids;
(d) the known mixing bottles do not comprise a functional funnel which can be used as a storage compartment for one component (such as the solute in a solution) and then as a means of penetrating the bottle's permeable membrane; and
(e) none of the known mixing bottles comprise a twist action combining feature allowing users to introduce different substances with just a twist of the bottle cap.

Therefore, there is a need for an improved method and apparatus for combining drink components with quick mixing functionality so multiple components may be separated within a single container prior to use. The present invention effectuates these needs.

### SUMMARY

In accordance with one embodiment, an improved mixing bottle comprised of at least two chambers, a top chamber and a bottom chamber, is envisioned. In one embodiment, said chambers may be separated from one another, on the outside, by a freshness seal and, on the inside, by a permeable membrane.

In one embodiment of the top chamber, the interior will contain a wide mouth funnel. In one embodiment of said funnel, it may have a wide end and a narrow end. While the freshness seal is still in tact, the narrower end of the funnel may point towards the bottom chamber and be situated somewhere just above the permeable membrane.

The manner in which the mixing bottle apparatus is assembled has a number of advantages. The freshness seal separating the top compartment from the bottom compartment ensures the membrane separating the two compartments on the inside cannot be penetrated accidentally. There is sufficient space between the narrow end of the wide mouth funnel and the membrane, when the freshness seal is intact, to ensure the integrity of the membrane is permanently maintained.

Once the freshness seal is removed from the outside of the mixing bottle, the top and bottom compartment are free to move closer to one another. When the two are sufficiently close, the narrow end of the wide mouth funnel will come into contact with the permeable membrane and penetrate it.

Penetrating said membrane, will allow free flow of the contents of each compartment. Because the funnel has a wide mouth on the narrow end, shaking the mixing bottle will allow the contents of the bottom compartment to enter and mix with the contents of the top compartment. Similarly, the contents of the top compartment will be free to interact with the contents of the bottom compartment forming a new solution once the solute and solvent coalesce.

It is envisioned that in one embodiment the top compartment and bottom compartment may be screwed together using a threaded neck and threaded collar. Such a configuration would prevent the contents of the bottle from leaking out while the bottle is shaken.

In this embodiment, the externally threaded neck and internally threaded collar may be interchangeably placed on either the top compartment or bottom compartment. It is further envisioned that, when unscrewed, the two compartments would be separated by a distance approximately equal to this thickness of the freshness seal. Once the seal is removed, there is no longer a barrier preventing the top and bottom compartments from being screwed together. Therefore, twisting the two compartments will bring the bottom of the integral top compartment funnel closer to the permeable membrane and eventually puncture it.

It is envisioned that the permeable membrane may be made up of different types of materials. By way of example and not limitation, in one embodiment, the permeable membrane may be made of aluminum foil. In yet another embodiment, the permeable membrane may be made easy to puncture through a variety of different means. These means include, but are not limited to, making the membrane thinner around the point where it would come into contact with the narrow end of the funnel, or perforating the center of the membrane.

The contents of the two compartments may dictate the type of membrane to be used. Some substances may make it ideal to use aluminum as a penetrable membrane while, in other embodiments, a thin plastic such as Saran wrap may be preferable. The aforementioned examples are not meant to limit the materials from which said membrane may be composed.

The inventors further envision that, in one embodiment of the method and apparatus for mixing drinks, the top compartment may be divided into several other compartments. This would be beneficial in an embodiment of the mixing bottle where three or more components are to be separated prior to mixing the final solution.

Similarly, the inventors further envision, that in yet another embodiment, the bottom compartment may be divided into several other compartments. Furthermore, it is foreseeable that, in another embodiment, both the top and bottom compartments would be divided into multiple other compartments.

### Advantages

Thus several advantages of one or more aspects are to provide:
(a) a mixing bottle that prevents accidental mixing of the separate components contained therein;
(b) a mixing bottle that comprises a penetrable membrane that can be easily ruptured via a storage chamber funnel;
(c) a mixing bottle that works equally well whether the separate components are solids or liquids;
(d) a mixing bottle that comprises a functional funnel which can be used as a storage compartment for one component and then as a means of penetrating the bottle's permeable membrane;
(e) a mixing bottle comprising a twist action combining feature allowing users to introduce different substances with just a twist of a bottlecap;
(f) a mixing bottle capable of storing two or more separate components while only needing two compartments; and
(g) a mixing bottle that will allow all of these components to be mixed by using a simple pull and twist mechanism.

These and other advantages of one or more aspects will become apparent from consideration of the ensuing description and accompanying drawings. Although the description above contains many specificities, these should not be construed as limiting the scope of the embodiments but as merely providing illustrations of some of several embodiments. For example, the mixing bottle may be constructed from plastic in one embodiment and with aluminum or other suitable material for drinking containers in another. Thus the scope of the embodiments should be determined by the claims that are appended and their legal equivalents, rather than by the examples given.

The description of the invention which follows, together with the accompanying drawings should not be construed as limiting the invention to the example shown and described, because those skilled in the art to which this invention pertains will be able to devise other forms thereof within the ambit of the appended claims.

### DESCRIPTION OF THE DRAWINGS

Figures

FIG. 1 is a perspective view of the mixing apparatus with freshness seal intact;

FIG. 2 is a side view of the mixing apparatus with freshness seal intact;

FIG. 3 is a sectional view of the mixing apparatus with freshness seal intact;

FIG. 4 is a perspective view illustrating how the freshness seal may be removed;

FIG. 5 is a side view illustrating how the top compartment and bottom compartment may be screwed together once the freshness seal is removed; and

FIG. 6 is a sectional view illustrating the permeable membrane once it has been ruptured by the narrow end of the top compartment funnel and the contents of the top compartment have been emptied into the bottom compartment.

Reference Numerals

| | | | |
|---|---|---|---|
| 10 | mixing apparatus | 12 | top compartment |
| 14 | bottom compartment | 16 | freshness seal |
| 18 | permeable membrane | 20 | first isolated component |
| 22 | second isolated component | 24 | externally threaded neck |
| 26 | internally threaded collar | 28 | narrow end of funnel |
| 30 | mixed solution | | |

### DETAILED DESCRIPTION

Illustrative embodiments of the invention are described below. The following explanation provides specific details for a thorough understanding of an enabling description for these embodiments. One skilled in the art will understand that the invention may be practiced without such details. In other instances, well-known structures and functions have not been shown or described in detail to avoid unnecessarily obscuring the description of the embodiments.

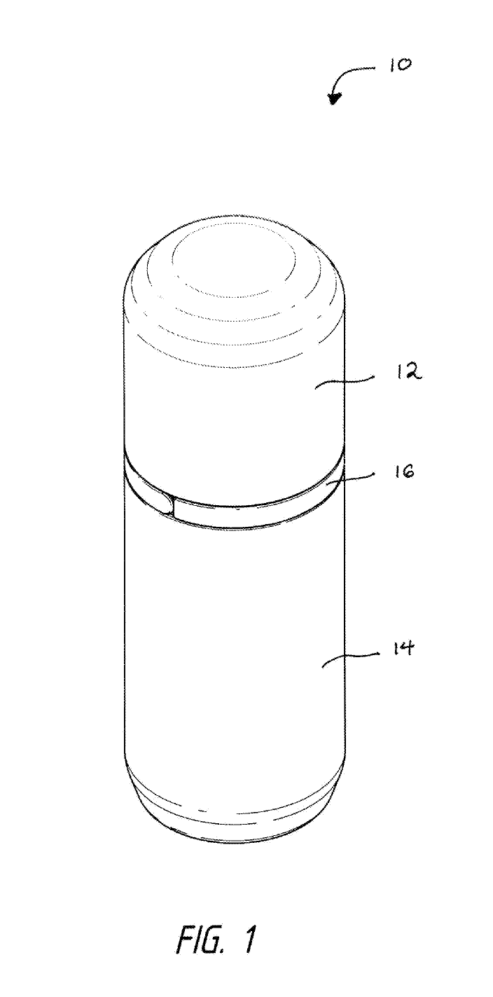

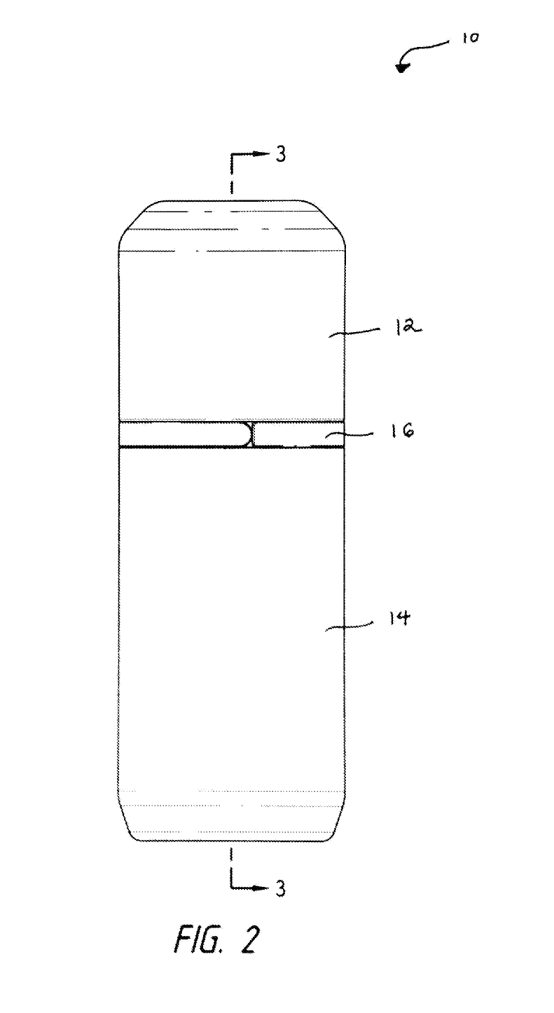

One embodiment of a method and apparatus for mixing drinks is illustrated in FIG. 1 & FIG. 2. FIG. 1 & FIG. 2 illustrate the mixing apparatus 10 with the freshness seal 16 still intact. The freshness seal 16 wraps around the outside of the mixing apparatus 10 and is positioned between the top compartment 12 and the bottom compartment 14.

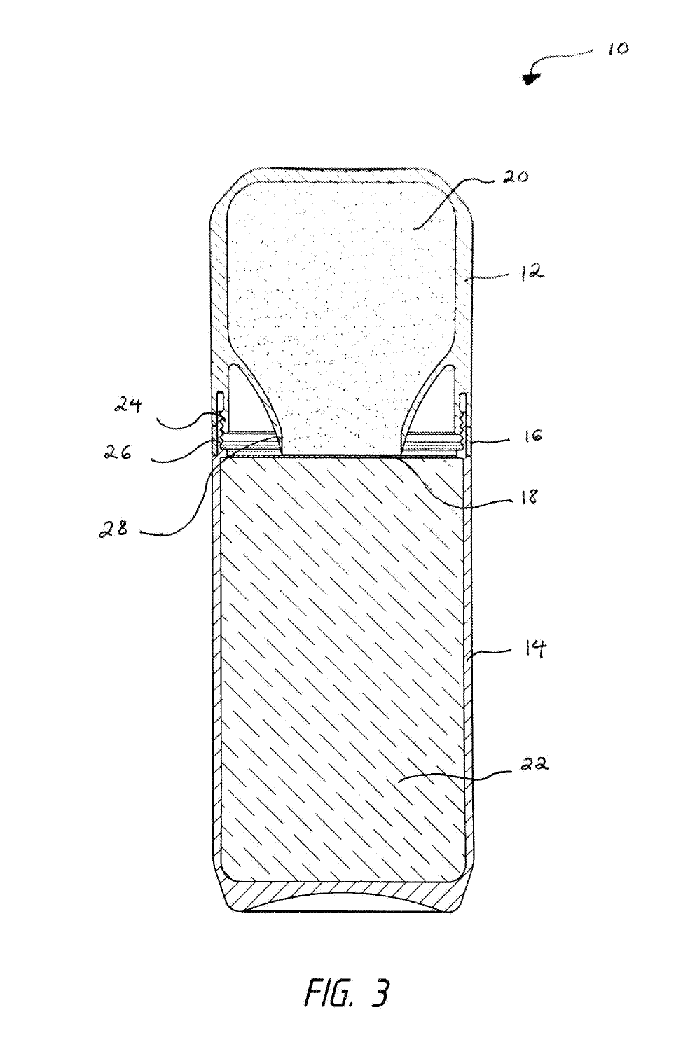

FIG. 3 is a cross section of the mixing apparatus 10 with the freshness seal 16 still in tact. In this embodiment of the mixing apparatus 10, the top compartment 12 is coupled to the bottom compartment 14 with an externally threaded neck 24 on the top compartment 12 and an internally threaded collar 26 on the bottom compartment 14 of the mixing apparatus 10. In other embodiments, the threaded neck and collar may be interchanged while still accomplishing the same result of coupling the top compartment 12 and the bottom compartment 14.

FIG. 3 also illustrates the top compartment 12 with its integral widemouth funnel. In this embodiment, the top compartment 12 only contains one isolated component 20. However, it is foreseeable that, in other embodiments, the top compartment 12 may be modified to contain multiple isolated component. Each component may foreseeably be separated by a membrane running from the top to the bottom of the integral funnel.

FIG. 3 further illustrates, in cross-section, the mixing apparatus 10 with the permeable membrane 18 still intact. The permeable membrane 18 is located towards the top of the bottom compartment 14 and is situated just below the narrow end of the funnel 28. The size of the gap between the narrow end of the funnel 28 and the permeable membrane 18 is dictated by the thickness of the freshness seal 16 and the aforementioned threaded neck and collar. Because the freshness seal 16 is still intact, the top compartment 12 cannot be twisted down and the permeable membrane 18 cannot be punctured.

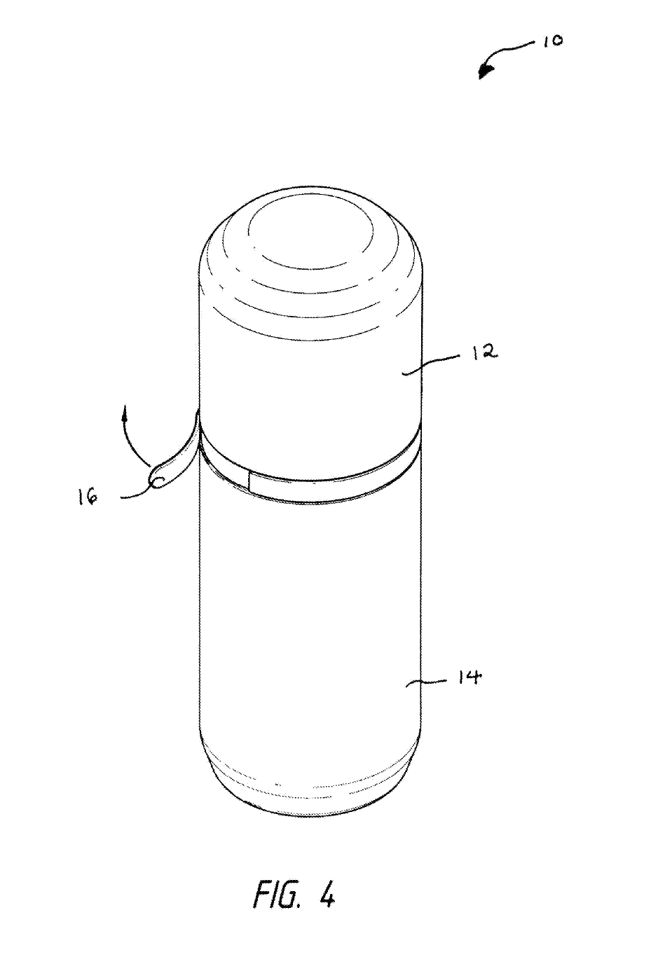

Referring to FIG. 4, the mixing apparatus 10 is shown here in perspective view with freshness seal 16 only partially intact. FIG. 4 illustrates how the freshness seal 16 wraps around the entire circumference of the mixing apparatus 10 in between the top compartment 12 and the bottom compartment 14. FIG. 4 also illustrates how the freshness seal 16 may be removed by lifting one end then peeling off the rest.

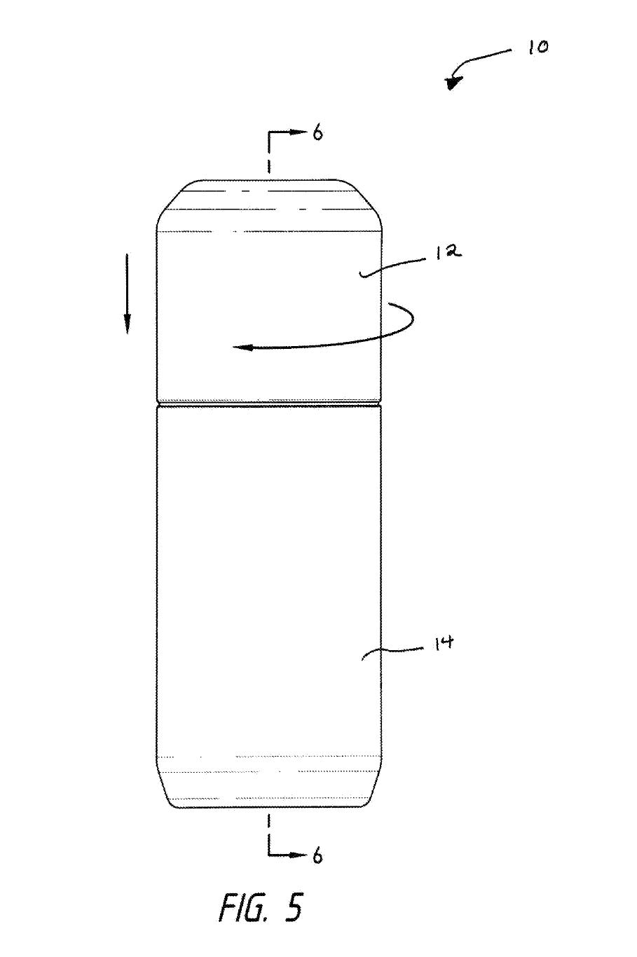

Once the freshness seal 16 is completely removed, the top compartment 12 and bottom compartment 14 are free to be screwed together. This may be accomplished by rotating either of the two compartments. FIG. 5 illustrates how rotating the top compartment 12 will bring it closer to the bottom compartment 14. Once the two compartments are completely screwed together, the permeable membrane 18 contained within the mixing apparatus 10 will be punctured.

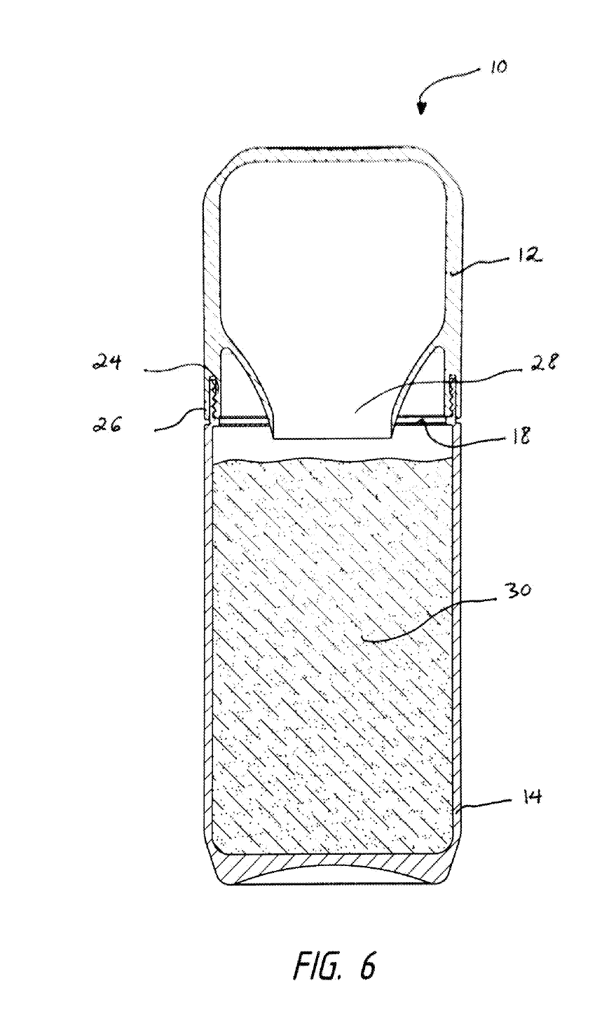

FIG. 6 is a sectional view of the mixing apparatus 10 once the permeable membrane 18 has been punctured and the contents of the top compartment 12 have been emptied into the bottom compartment 14. The freshness seal 16 is no longer attached and the top and bottom compartments have been screwed together. As a result, the bottom end of the funnel 28 has punctured the permeable membrane 18 and the solute and solvents are now mixed together to form an entirely new solution 30.

The relatively wide mouth at the narrow end of the funnel 28 is useful for allowing the solution 30 to move back and forth between the top compartment 12 and the bottom compartment 14 further facilitating the mixing process. The mixing apparatuses 10 threaded neck 24 and collar 26 create a seal preventing the solution 30 from leaking out while the mixing apparatus 10 is being shook. In one embodiment, a rubber gasket may be disposed around the threaded neck or collar to provide a liquid impermeable seal between the top compartment 12 and the bottom compartment 14.

Once the components of the final solution have been mixed, the top compartment 12 may be unscrewed from the bottom compartment 14 and a user may drink the final solution 30 from the bottom compartment 14.

It is envisioned that the permeable membrane 18 may be comprised of a variety of different materials and compositions. In one embodiment, the permeable membrane 18 may be comprised of a thin sheet of aluminum foil much like that found on a medicine container. In one embodiment of the membrane 18, it may be perforated for easier puncturing. In another embodiment, it may be composed of a thin plastic such as Saran wrap. The contents of the top compartment 12 and bottom compartment 14 and their reactivity with the membrane will dictate the type of material and how it is composed. Therefore, the inventors do not intend to limit their invention to the exact details of construction and enumeration of parts described above. The same should apply to the materials with which the mixing apparatus 10 is comprised. This includes but is not limited to plastic, aluminum, and stainless steel. Finally, the appended drawings are not intended to be restrictions on the relative size or shape of the mixing apparatus 10.

### Conclusions, Ramifications, and Score

While a particular form of the invention has been illustrated and described, it will be apparent that various modifications can be made without departing from the spirit and scope of the invention. For example, the permeable membrane may be made from aluminum foil that is perforated in the center even though the inventors contemplate the possibility that it may also be made thinner in the middle to facilitate the puncturing step. Accordingly, is not intended that the invention be limited, except as by the appended claims.

The teachings provided herein can be applied to other systems, not necessarily the system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Particular terminology used when describing certain features or aspects of the invention should not be taken to imply that the terminology is being refined herein to be restricted to any specific characteristics, features, or aspects of the method and apparatus for mixing drinks with which that terminology is associated. In general, the terms used in the following claims should not be constructed to limit the mixing apparatus and method to the specific embodiments disclosed in the specification, unless the above Detailed Description section explicitly define such terms. Accordingly, the actual scope encompasses not only the disclosed embodiments, but also all equivalent ways of practicing or implementing the disclosed mixing apparatus and method. The above detailed description of embodiments of the method and apparatus for mixing drinks is not intended to be exhaustive or limited to the precise form disclosed above or to a particular field of usage. While specific embodiments of, and examples for, the method and apparatus for mixing drinks are described above for illustrative purposes, various equivalent modifications are possible which those skilled in the relevant art will recognize.

While certain aspects of the method and apparatus for mixing drinks are presented below in particular claim forms, the inventors contemplate the various aspects of the method and apparatus for mixing drinks in any number of claim forms. Accordingly, the inventors reserve the right to add additional claims after filing the application to pursue such additional claim forms for other aspects of the method and apparatus for mixing drinks.

What is claimed is:

1. A dual compartment mixing bottle comprising:
a first compartment with an integral funnel;
a second compartment attachable to said first compartment, said second compartment having an upper end with a permeable membrane positioned thereon;
a freshness seal positioned between said first compartment and said second compartment removably attached to the outside of said mixing bottle.

2. The mixing bottle of claim 1 wherein said first compartment is comprised of at least two chambers separated by at least one membrane.

3. The mixing bottle of claim 1 wherein said second compartment is comprised of at least two chambers separated by at least one membrane.

4. The mixing bottle of claim 1 wherein said permeable membrane is comprised of aluminum foil.

5. The mixing bottle of claim 1 wherein said permeable membrane is comprised of plastic.

6. A method of mixing drinks comprised of at least one solvent and one solute, comprising the steps of:
(a) providing a top compartment with an integral funnel contained therein;
(b) providing a bottom compartment;
(c) providing a freshness seal;
(d) providing a permeable membrane;
(e) placing at least one substance in said top compartment, placing at least one different substance in said bottom compartment, placing said permeable membrane over the top of said bottom compartment, screwing said top compartment into the top of said bottom compartment, placing said freshness seal in between said top and said bottom compartment; and
(f) removing said freshness seal, screwing said top compartment and said bottom compartment together so as to allow the integral funnel to puncture said permeable membrane, and shaking said top compartment and said bottom compartment together.
